(19) United States
(12) Patent Application Publication
(10) Pub. No.: US 2008/0280710 A1
(43) Pub. Date: Nov. 13, 2008

(54) Guiding Unit for a Traction Mechanism Drive

(75) Inventors: Rainer Fuhrmann, Waischenfeld/Nankendorf (DE); Bert Kroon, Erlangen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/090,665

(22) PCT Filed: Sep. 6, 2006
(86) PCT No.: PCT/EP2006/066073

§ 371 Date: Apr. 18, 2008

(30) Foreign Application Priority Data
Oct. 21, 2005 (DE) 10 2005 050 531.7

(51) Int. Cl. F16H 7/08

(52) U.S. Cl. 474/109

(57) ABSTRACT

The invention relates to a guide unit (1a) associated with a traction drive means, which guide unit (1a) comprises a tensioning element (3a) and a guide element (4a). The components: the tensioning element (3a) and guide element (4a), which are displaceable separately from one another with respect to a housing (2), are associated with separate regions of the traction means (8) in the operating state of the traction means drive.

### FIELD OF THE INVENTION

The present invention relates to a traction means drive, in particular in the form of a chain drive of an internal combustion engine, which is also referred to as a synchronizing drive. This traction means drive comprises at least one drive wheel and at least one driven wheel which are connected via a traction means. The traction means drive further includes a force-loaded guide unit which cooperates with the traction means in at least two regions separate from one another.

### BACKGROUND OF THE INVENTION

Traction means drives of this type are used in internal combustion engines, preferably for driving one or more camshafts. The camshaft drive of an internal combustion engine requires a synchronizing drive between the output shaft and the input shaft which ensures a phase-exact, i.e. precisely coordinated, rotational speed between the crankshaft and the camshaft of the internal combustion engine in all operating states. For this purpose, chain drives or toothed-belt drives are preferably used as traction means in present-day internal combustion engines. Such traction means drives are alternatively used for assembly drives with which, for example, the generator, the water pump and the air-conditioning compressor of an internal combustion engine are driven.

The functioning of a traction means drive designed as a synchronizing drive requires a sufficiently pretensioned traction means by which disadvantageous jumping of teeth can be prevented. To this end, it is known, for example, to use a hydraulically-acting or spring-loaded tensioning system which includes a tensioning roller or tensioning rail bearing non-positively against the traction means. In addition to a sufficiently pretensioned traction means, the tensioning system further has a function of compensating for length changes of the traction means caused by wear or temperature changes, for example.

A traction means drive in which the tensioning system is associated with only one region, preferably the idling section of the traction means, disadvantageously causes a rotational deviation, accompanied by a phase error, between the shafts rotating in functionally-required synchronization. Because of the phase error arising, which detrimentally influences the exhaust gas quality of the internal combustion engine, such tensioning systems are unsuitable for present-day internal combustion engines.

Known from U.S. Pat. No. 6,358,169 D1 is a chain-tensioning system with a rotatable tensioning arm which acts on the chain simultaneously via two separate tensioning or guide arms. This structure is intended to damp oscillations or vibrations occurring in one section of the chain by transmitting oscillations via the tensioning arm to a further section of the chain. This structure disadvantageously results in a device in which both the tensioning rail and a spring means are arranged outside the traction means drive, disadvantageously increasing the required installation space.

DE 26 55 102 A1 illustrates and describes a tensioning system for a traction means drive which acts on the traction means in two positions separate from one another. A first rotatable tensioning arm is provided at one end with a roller which acts non-positively on the traction means in the operating state. At its end oriented away from the tensioning roller, the tensioning arm is further connected to a rotatably mounted guide rail which is associated with a further section of the traction means. This known tensioning system requires components of large dimensions associated with an increased installation space requirement, individual components of the tensioning system being arranged outside the traction means drive.

JP 2001 317 600 A discloses a tensioning system with two tensioning arms connected to one another in one piece. The tensioning arms, swivelable about a common axis of rotation, bear non-positively against two separate sections of the traction means via guide surfaces. Both tensioning arms of the tensioning system engage the traction means on the outside.

### OBJECT OF THE INVENTION

It is the object of the present invention to provide a compact device with which the traction means of a traction means drive can be guided optimally in all operating states, in conjunction with a reduction in force peaks in the traction means section.

### SUMMARY OF THE INVENTION

This object is achieved according to the invention by a guide unit which preferably comprises a tensioning element and preferably at least one guide element which are associated with separate regions of the traction means and are connected to one another via a common housing. In the operating state of the traction means drive, the guide element is preferably allocated to a traction section and the tensioning element preferably to the idling section of the traction means. Alternatively, the invention includes a guide unit comprising exclusively guide elements or tensioning elements. Furthermore, separate displacement of the individual elements is provided in the operating state for the guide unit according to the invention, for which purpose these elements are force-loaded by separate mechanical or hydraulic spring means. To this end the spring means are positioned in each case between the housing or a component or abutment element connected to the guide unit and the individual elements. As a result of the invention, the traction means is optimally guided and/or pretensioned in all operating states, force peaks in the traction means, in particular in the traction section thereof, being reduced at the same time.

The inventive guide unit, also referred to as a motion module, with movably or displaceably associated force-loaded elements: the guide element and the tensioning element, makes possible advantageous compensation or reduction of force peaks occurring in the traction means, which advantageously affects wear, noise and service life.

The inventive guide unit makes possible optimum pretensioning and guidance of the traction means without the occurrence of a disadvantageous phase shift between the drive and driven shafts of the traction means drive. The invention further influences the pretensioning of the traction means, which is advantageously reduced, therefore at the same time reducing the force on the traction means. Because the force on the traction means directly influences its durability, the use of the inventive guide unit increases the service life of the whole traction means drive.

To underline the compact construction of the inventive guide unit, it encompasses all the components, such as the housing, the swivelable or displaceable guide elements and the associated spring means. Because the guide elements of the guide unit are preferably associated with the traction means on the inside, installation, especially of the traction means, is simplified, yielding a further cost advantage of the guide unit according to the invention.

Further advantageous configurations of the invention are the subject matter of the dependent claims 2 to 18.

To achieve a weight advantage of the inventive guide unit, the components: the housing, the guide element and the tensioning element, are made of aluminum. This material also reduces the required expenditure for mechanical finishing operations, leading to a further cost advantage. Plastics material may also be used as a suitable alternative material for the individual components of the guide unit.

Alternatively, the invention includes a guide unit in which the guide element and/or the tensioning element is/are combined with guide shoes made of plastics material. Through the selection of a suitable, wear-resistant plastics material, this construction makes possible longer service life and an advantage with regard to noise generation by the traction means drive.

In addition, the invention includes a guide unit the components of which—housing, guide element and tensioning element—are made of different plastics or materials. For this purpose, it is appropriate to select the materials for the individual components while having regard to the respective stresses thereon, in order to achieve optimum wear-resistance and strength, and low cost. An exemplary design provides for any desired combination of components made of aluminum and plastics material for the guide unit.

The inventive structure of the guide unit may advantageously be supplemented by further components in order, for example, to improve the guidance or pretensioning of the traction means of a traction means drive. For this purpose the guide unit may comprise, for example, more than one guide element and/or more than one tensioning element, which directly influence the pretensioning and damping of the traction means. To this end, it is appropriate for individual elements of the guide unit to be associated with the traction means in separate regions of the idling section or of the traction section.

For displacement of the individual elements, they are preferably connected via an axis of rotation to the housing of the guide unit. Alternatively to a swivelable displacement of the tensioning element or the guide element, a linearly displaceable arrangement is also appropriate according to the invention.

The tensioning element is preferably displaced linearly. To implement cost-effective linear guidance, a pin fixed positionally in the tensioning element and displaceable in a corresponding bore of the housing is preferably suitable. In this case the linear guide, preferably arranged axially with respect to a spring means of the guide rail, at the same time forms an anti-twist device for the guide element.

According to a preferred structure of the guide unit, the axis of rotation and the spring means are associated with separate ends of the tensioning element and of the guide element. Alternatively, the invention includes the arrangement of spring means with high actuating force which are positioned a short distance from the axis of rotation.

As force means, a cylindrical helical compression spring is advantageously suited. In this case a first end of the helical compression spring is preferably centered in a bore of the housing and the other end of the spring in a corresponding bore of the tensioning element or guide element. This measure prevents disadvantageous buckling of the helical compression spring. A guide unit in which the individual parts: the housing, the guide element and the tensioning element, are made of aluminum may, according to the invention, include steel disks via which the ends of the helical compression springs bear in the bores. This measure advantageously reduces surface pressure in the support region of the helical compression spring.

The displacement of the individual elements of the guide unit is further possible by means of electrical energy, for example with a servo motor, or via the oil pressure of a pressure circulating lubrication system of the internal combustion engine. Alternatively, it is also appropriate according to the invention to use a hydraulically-acting actuator or actuating cylinder as the force means. A drive for subjecting the guide unit to the oil pressure of the internal combustion engine advantageously comprises a hydraulic actuator consisting of a hydraulically-pressurized piston connected to the tensioning element or the guide element. For improving the operation of the actuator, a non-return valve is included therein between a hydraulic high-pressure chamber and a reservoir. Through this measure a desired, damped coupling of the element connected to the hydraulically-pressurized piston can be achieved. To displace the piston, the hydraulic fluid flows from the high-pressure chamber via the non-return valve into the reservoir. An inverse, retarded volume exchange can take place via a leakage gap provided between the high-pressure chamber and the reservoir. As a non-return valve, a valve unit consisting of a spring-loaded ball which closes a cross-section in the first flow direction and opens same in the opposite direction after a spring force has been overcome, is preferably used.

In the installed state a coincidence between a stub bore of the guide unit and a bore of the internal combustion engine is established, whereby the hydraulic fluid, the lubricating oil from an oil gallery of the internal combustion engine, directly pressurizes the high-pressure chamber of the hydraulic actuator.

As an effective measure for eliminating the noise generation of the guide unit, an elastic end stop is associated with the tensioning element and/or the guide element. A component configured as a rubber or plastics plug inserted in a blind bore and projecting with an excess length with respect to an abutment face, is suitable for this purpose. This component may be associated as desired with the housing or with the tensioning element or guide element. The elastic end stop effectively prevents abutment of the displaceable element against the housing. In particular in the case of a traction means drive excited by oscillations in which the tensioning element and/or the guide element oscillate/s at high frequency, the elastic end stop prevents disadvantageous knocking of the movable element against the housing.

The invention further comprises a guide unit the tensioning element and/or guide element of which includes on both sides edge flanges formed directly thereon, or on a guide shoe associated with these components. The axially-spaced edge flanges, extending over the full length of each outer side, improve the guidance of the traction means in the region of the guide elements.

The inventive guide unit is further provided with anti-loss devices or assembly devices. These devices ensure close proximity of the displaceable elements to the housing and to the elastic end stop. At the same time the anti-loss devices simplify assembly, especially fitting of the traction means, and also ensure that all components belonging to the guide unit are held together during transportation.

The housing of the inventive guide unit is also provided with bores for fixing screws with which the guide unit can be fixed detachably, for example to the crankcase of an internal combustion engine.

### BRIEF DESCRIPTION OF THE DRAWINGS

Exemplary embodiments of the guide unit according to the invention are described in more detail below and are represented in the figures, in which:

FIG. 1 is a perspective view of the structure of a guide unit according to the invention;

FIG. 2 shows the guide unit according to FIG. 1, in which individual details are shown in cut-away form for clarity;

FIG. 3 shows a guide unit constructed alternatively to FIG. 1, in which both the tensioning element and the guide element are swivelable via an axis of rotation.

### DETAILED DESCRIPTION OF THE DRAWINGS

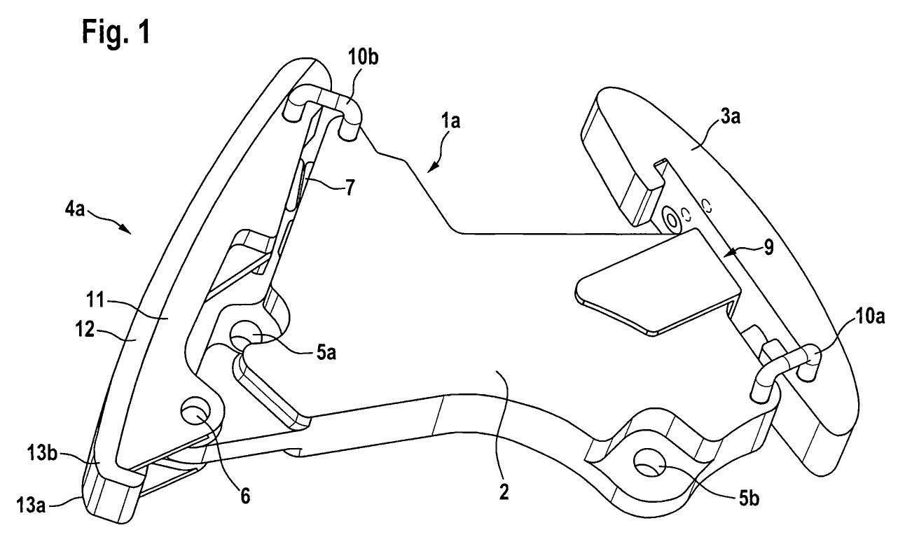

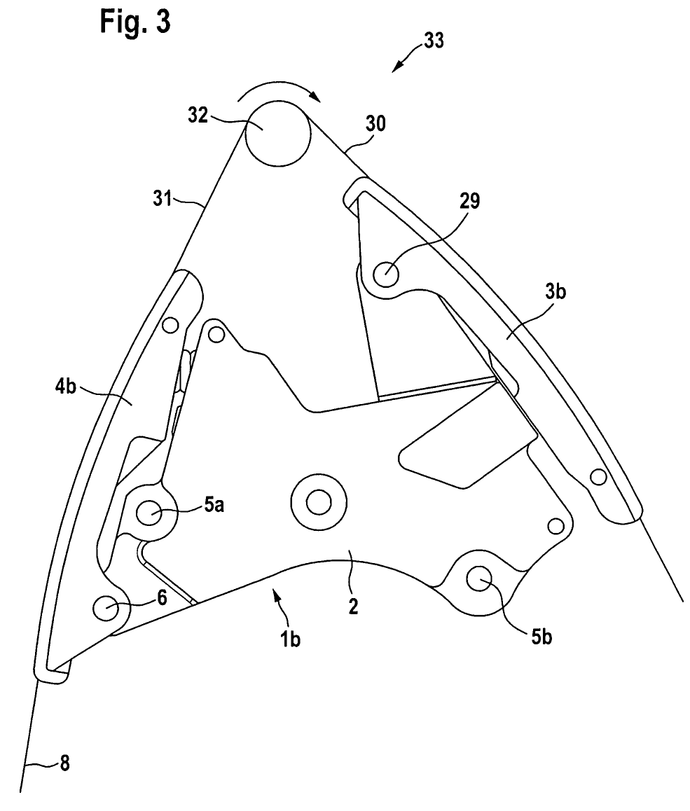

According to the exemplary embodiment shown in FIG. 1, in which a guide unit 1a is shown in a perspective view, said guide unit 1a comprises essentially the components: a housing 2 on which a tensioning element 3a and a guide element 4a are arranged movably. The guide unit 1a, which forms a constructional unit, can be fixed detachably by means of screw fixings which are inserted in bores 5a, 5b, for example to an internal combustion engine (not shown in FIG. 1). The guide element 4a is connected swivelably to the housing 2 via an axis of rotation 6. A force means designed as a helical compression spring 7, which in the operating state of the guide unit 1a ensures that the guide element 4a bears non-positively against a traction means 8 illustrated in FIG. 3, is inserted at an axial distance from the axis of rotation 6 between the housing 2 and the guide element 4a.

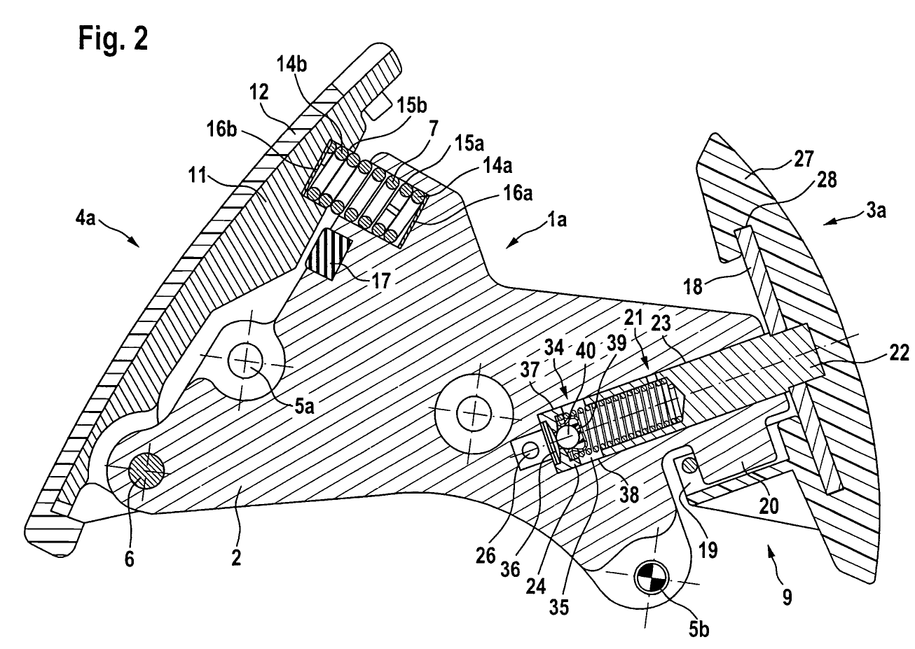

The tensioning element 3a is displaceable with respect to the housing 2 via a linear guide 9. To achieve non-positive abutment of the tensioning element 3a against the traction means 8, a force means, illustrated in detail in FIG. 2, is provided between the housing 2 and the tensioning element 3. Correspondingly, the tensioning element 3a and the guide element 4a are shown in FIG. 1 in a transportation or assembly position in which these components are positioned a short distance from the housing 2. To this end, this positioning is maintained by means of anti-loss devices 10a, 10b, which are removed after installation of the guide unit 1a and fitting of the traction means 3, so that the tensioning element 3a and the guide element 4a swivel or are displaced in the direction of the traction means 8 as a result of the associated force means. The guide element 4a has a two-part structure, consisting of a carrier 11 to the outside of which a guide shoe 12 is positionally fixed in a form-fitting manner. The guide shoe 12 is provided on both sides with edge flanges 13a, 13b. The edge flanges 13a, 13b, extending over the full length of the guide shoe 12, effect secure guidance of the traction means 8 against the guide element 4a.

FIG. 2 makes clear individual details of the guide unit 1a according to FIG. 1. The cylindrical helical compression spring 7 provided for spring-loading the guide element 4a is inserted with one end 14a in a bore 15a of the housing 2 and with the other end 14b in the corresponding bore 15b of the guide element 4a. In order to reduce surface pressure in the region of a circular support area of both spring ends 14a, 14b, a steel disk 16a, 16b is associated with each spring end 14a, 14b, in particular for a housing 2 or guide element 4a or tensioning element 3a made of aluminum or plastics material. An elastic end stop 17 positioned between the housing 2 and the guide element 4 has the function of preventing direct abutment of the guide element 4a against the housing 2. The elastic end stop 17 therefore prevents disadvantageous noise generation which is caused, for example, by swiveling movements of the guide element 4 induced by oscillations of the traction means 7.

The linear guide 9 makes possible rectilinear displacement of the tensioning element 3a with respect to the housing 2. To this end, a straight projection 19 is provided on a sliding shoe 27 of the tensioning element 3a, which projection 19 engages form-fittingly in and is guided displaceably in a U-shaped receptacle 20 having two axially-spaced walls. For force-loading the tensioning element 3a, a force means in the form of a hydraulic actuator 21 is provided axially offset to the linear guide 9. The structure of the hydraulic actuator 21 includes a piston 22 displaceable in a fitting bore 23 of the housing 2 and connected to the carrier 18 of the tensioning element 3. A compression spring 25, which in the operating state exerts on the tensioning element 3a a force directed in the direction of the traction means 8, is inserted between a base 24 of the fitting bore 23 and the piston 22.

The piston 22 is further impinged upon by a pressure medium. For pressurization of the piston 22 with a pressure medium, the fitting bore 23 is connected via a stub bore 26 to, for example, an oil gallery of the internal combustion engine. This construction enables the piston 22 to be pressurized with a hydraulic fluid of the pressure circulation lubrication system of the internal combustion engine, in order to load the tensioning element 3 in a non-positive manner. To influence the pressure, the use of an aperture or a pressure-limiting valve which is inserted, for example, in the region of the stub bore 26, is appropriate. Comparably to the guide element 4a, the tensioning element 3a is provided with a sliding shoe 27 made, for example, of plastics material, which in the operating state bears against the traction means 8 on the inside. For fixing of the sliding shoe 27, the latter has a receptacle 28 in which the carrier 18 is inserted form-fittingly.

Alternatively, it is appropriate to use as a force means a hydraulically-acting actuator or actuating cylinder consisting of the hydraulically-pressurized piston 22 connected to the tensioning element 3a. A drive of the actuator is effected by the oil pressure of the internal combustion engine. To improve the operation of the actuator, it includes a non-return valve 34 arranged therein between a hydraulic high-pressure chamber and a reservoir. Through this measure the desired, damped coupling of the tensioning element 3a connected to the piston 22 can be achieved. For displacement of the piston 22, the hydraulic fluid flows from the high-pressure chamber 35 via the non-return valve 34 into the reservoir 36. An inverse, retarded volume exchange from the high-pressure chamber 35 to the reservoir 36 is effected via a leakage gap 37, which is formed between an inner wall 38 of the fitting bore 23 and the non-return valve 34. The non-return valve 34 comprises a ball 40 loaded by a spring 39 which opens a cross section in the first flow direction and closes the cross section in the opposite direction.

FIG. 3 shows the guide unit 1b in which both the tensioning element 3b and the guide element 4b are arranged swivelably via an axis of rotation 6, 29 which each form a pivot bearing with the housing 2. Correspondingly, the components: the tensioning element 3b and the guide element 4b bear against the traction means 8 on the inside. The traction means drive 33 illustrated partially in FIG. 3 shows, in addition to the guide unit 1b, an output wheel 32 rotating clockwise and associated with the internal combustion engine, for example a toothed-belt pulley or chain sprocket connected directly to a crankshaft of the internal combustion engine. The tensioning element 3b of the guide unit 1b is associated with the traction means 8 in the region of the idling section 30, and the guide element 4b with the traction means 8 in the region of the traction section 31.

### LIST OF REFERENCES

1a Guide unit
1b Guide unit
2 Housing
3a Tensioning element
3b Tensioning element
4a Guide element
4b Guide element
5a Bore
5b Bore
6 Axis of rotation
7 Helical compression spring
8 Traction means
9 Linear guide
10a Anti-loss device
10b Anti-loss device
11 Carrier
12 Guide shoe
13a Edge flange
13b Edge flange
14a Spring end
14b Spring end
15a Bore
15b Bore
16a Steel disk
16b Steel disk
17 End stop
18 Carrier
19 Projection
20 Receptacle
21 Actuator
22 Piston
23 Fitting bore
24 Base
25 Compression spring
26 Stub bore
27 Sliding shoe
28 Receptacle
29 Axis of rotation
30 Idling section
31 Traction section
32 Driven wheel
33 Traction means drive
34 Non-return valve
35 High-pressure chamber
36 Reservoir
37 Leakage gap
38 Inner wall
39 Spring
40 Ball

1. A guide unit for a traction means drive, in particular chain drive of an internal combustion engine, comprising: at least one drive wheel; and at least one driven wheel connected to the drive wheel by a traction means, the guide unit being in effective connection with the traction means by means of force-loaded components in at least two regions separate from one another, wherein:
the guide unit includes at least one tensioning element and at least one guide element connected to the tensioning element by a common housing;
the guide element and the tensioning element being associated with separate sections of the traction means drive;
the tensioning element and the guide element bearing against the traction means on the inside in the operating state;
the guide element and the tensioning element being displaced separately;
both the guide element and the tensioning element being force-loaded by separate spring means or force means connected to the housing.

2. The guide unit of claim 1, wherein the housing, the tensioning element and the guide element are made of aluminum.

3. The guide unit of claim 1, wherein the tensioning element and the guide element are fitted with a guide shoe or sliding shoe made of plastics material.

4. The guide unit of claim 1, wherein the housing, the tensioning element and the guide element are made of a plastic material.

5. The guide unit of claim 1, further comprising: a plurality of tensioning elements; and a plurality of guide elements.

6. The guide unit of claim 1, wherein the clamping element and the guide element are each arranged swivelably about an axis of rotation.

7. The guide unit of claim 1, further comprising: at least one linearly displaceable tensioning element and a linearly displaceable guide element.

8. The guide unit of claim 7, wherein a pin cooperates with a corresponding bore of the housing and is positionally fixed in the tensioning element to form a linear guide.

9. The guide unit of claim 8, wherein the linear guide forms an anti-twist device for the tensioning element.

10. The guide unit of claim 1, wherein a first end of the guide element and a first end of the tensioning element are associated with the axis of rotation and the other end of the guide unit and the other end of the tensioning element are associated with the force means.

11. The guide unit of claim 1, wherein a cylindrical helical compression spring impinges on the tensioning element or the guide element and is used as the force means.

12. The guide unit of claim 11, wherein spring ends of the helical compression spring are centered in a bore of the housing and a bore of the guide element and are preferably supported therein via respective steel disks.

13. The guide unit of claim 1, wherein a force means in the form of a hydraulically-acting actuator or actuating cylinder is provided and impinges on the tensioning element and the guide element.

14. The guide unit of claim 1, wherein electrical energy or an oil pressure of the internal combustion engine is used as the force means for impinging on the tensioning element and the guide element.

15. The guide unit of claim 1, wherein an elastic end stop is provided between the tensioning element and guide element on one side and the housing on the other side.

16. The guide unit of claim 1, wherein the guide element, the guide shoe or the sliding shoe includes on both sides edge flanges guiding the traction means.

17. The guide unit of claim 1, wherein the tensioning element and the guide element can be positionally fixed with respect to the housing by means of an anti-loss device.

18. The guide element of claim 1, wherein the housing is to be fixed detachably, in particular by means of screw fixings, to a machine part, in particular of the internal combustion engine.
